(19) United States
(12) Patent Application Publication
(10) Pub. No.: US 2021/0075986 A1
(43) Pub. Date: Mar. 11, 2021

(54) CONFIGURABLE PIXEL READOUT CIRCUIT FOR IMAGING AND TIME OF FLIGHT MEASUREMENTS

(71) Applicant: SEMICONDUCTOR COMPONENTS INDUSTRIES, LLC, Phoenix, AZ (US)

(72) Inventor: Roger PANICACCI, Los Gatos, CA (US)

(73) Assignee: SEMICONDUCTOR COMPONENTS INDUSTRIES, LLC, Phoenix, AZ (US)

(21) Appl. No.: 16/947,017

(22) Filed: Jul. 15, 2020

Related U.S. Application Data
(60) Provisional application No. 62/897,801, filed on Sep. 9, 2019.

(51) Int. Cl. H04N 5/378; H04N 5/369; G01S 17/10; G01S 7/481; G01S 17/89

(52) U.S. Cl. CPC H04N 5/378; H04N 5/379; G01S 17/89; G01S 7/4814; G01S 17/10

(57) ABSTRACT

Imaging circuitry may include an array of pixels for capturing an image. A subset of the pixels in the array may be selected to perform depth sensing using region of interest (ROI) switching circuitry incorporated within an intermediate die that is stacked between a top image sensor die in which the array of pixels are formed and a bottom digital processing die. The imaging circuitry may be further provided with depth sensing circuitry having a current memory circuit, a current integrator circuit, a time-to-digital converter, and a loading circuit to compute a time of flight for a laser pulse by sensing changes in the pixel source follower gate current. Such depth sensing schemes may be applied to sense horizontally-oriented features, vertically-oriented features, diagonally-oriented features, or irregularly shaped features.

This application claims the benefit of provisional patent application No. 62/897,801, filed Sep. 9, 2019, which is hereby incorporated by reference herein in its entirety.

### BACKGROUND

This relates generally to imaging devices, and more particularly, to imaging devices having image sensor pixels on wafers that are stacked on other image readout/signal processing wafers.

Image sensors are commonly used in electronic devices such as cellular telephones, cameras, and computers to capture images. In a typical arrangement, an image sensor includes an array of image pixels arranged in pixel rows and pixel columns. Circuitry may be coupled to each pixel column for reading out image signals from the image pixels.

Image sensors that can perform both image capture and time-of-flight (TOF) measurements for depth sensing is desirable in many area such as automotive applications, robotics, virtual reality, and security cameras. Conventional TOF measurements require single photon avalanche detectors (SPADs) or silicon photomultipliers (SiPM) that rely on a specialized process to create high electric fields to generate avalanche conditions for charge multiplication in response to detecting a single photon. Other traditional ways of obtaining depth information also rely on active laser lighting schemes along with the use of indirect time-of-flight (iTOF) pixels with multiple high-speed storage gates in the pixel. Such specialized processes increase the pixel size, are not compatible with normal image capture schemes, and are therefore typically implemented on a separate sensor chip.

### BRIEF DESCRIPTION OF THE DRAWINGS

FIG. 1 is a diagram of an illustrative electronic device having an image sensor and processing circuitry for capturing images using an array of image pixels in accordance with some embodiments.

FIG. 2 is a diagram of an illustrated stacked imaging system in accordance with an embodiment.

FIG. 3 is a diagram of an illustrative image sensor array coupled to digital processing circuits and time-of-flight (depth-sensing) processing circuits in accordance with an embodiment.

FIG. 4 is a diagram showing how an image pixel may be connected to a particular region of interest (ROI) via various switch networks in accordance with an embodiment.

FIG. 5A is a diagram showing a camera module that is configured to obtain time-of-flight (TOF) measurements in accordance with an embodiment.

FIG. 5B is a timing diagram illustrating the operation of the camera module shown in FIG. 5A in accordance with an embodiment.

FIG. 6A is top level diagram illustrating image pixel circuitry configured to support TOF measurements in accordance with an embodiment.

FIG. 6B is a circuit diagram illustrating one suitable implementation of the pixel circuitry of FIG. 6A in accordance with an embodiment.

FIG. 6C is a diagram illustrating how imaging circuitry may be operable in an image sensing mode and a depth sensing mode in accordance with an embodiment.

FIG. 6D is a flow chart of illustrative steps for operating image pixel circuitry of the type shown in FIG. 6A-6B to perform depth sensing in accordance with an embodiment.

FIG. 7A is a timing diagram illustrating the operation of the pixel circuitry of the type shown in FIG. 6B when a single photon strikes one of the pixels in a group of ROI depth sensing pixels in accordance with an embodiment.

FIG. 7B is a timing diagram illustrating the operation of the pixel circuitry of the type shown in FIG. 6B when a single photon strikes two of the pixels in a group of ROI depth sensing pixels in accordance with an embodiment.

FIG. 7C is a timing diagram illustrating the operation of the pixel circuitry of the type shown in FIG. 6B when charge is detected during a designated time slot and how charge detected outside of the time slot does not affect the final result in accordance with an embodiment.

FIG. 8A is a diagram of an illustrative 8×8 pixel cluster in accordance with an embodiment.

FIG. 8B is a diagram of an illustrative ROI unit cell that includes four pixel clusters in accordance with an embodiment.

FIG. 8C is a diagram of another ROI cell formed at the bottom of each pixel column in accordance with an embodiment.

FIG. 9A is a diagram illustrating how row and column ROI selection can be controlled using row and column shift registers in accordance with an embodiment.

FIG. 9B is a diagram illustrating how row and column ROI selection can be configured to support horizontal feature depth sensing in accordance with an embodiment.

FIG. 9C is a diagram illustrating exemplary shapes that can be detected using the ROI selection scheme of FIG. 9B in accordance with an embodiment.

FIG. 9D is a diagram illustrating how row and column ROI selection can be configured to support vertical feature depth sensing in accordance with an embodiment.

FIG. 9E is a diagram illustrating exemplary shapes that can be detected using the ROI selection scheme of FIG. 9D in accordance with an embodiment.

FIG. 9F is a diagram illustrating how row and column ROI selection can be configured to support a +45° diagonal feature depth sensing in accordance with an embodiment.

FIG. 9G is a diagram illustrating exemplary shapes that can be detected using the ROI selection scheme of FIG. 9F in accordance with an embodiment.

FIG. 9H is a diagram illustrating how row and column ROI selection can be configured to support a −45° diagonal feature depth sensing in accordance with an embodiment.

FIG. 9I is a diagram illustrating exemplary shapes that can be detected using the ROI selection scheme of FIG. 9H in accordance with an embodiment.

FIG. 9J is a diagram illustrating how row and column ROI selection can be configured to perform depth sensing correlated with a predetermined shape in accordance with an embodiment.

FIG. 9K is a diagram illustrating exemplary shapes that can be detected using the ROI selection scheme of FIG. 9J in accordance with an embodiment.

### DETAILED DESCRIPTION

Electronic devices such as digital cameras, computers, cellular telephones, and other electronic devices may include image sensors that gather incoming light to capture an image. The image sensors may include arrays of image pixels. The pixels in the image sensors may include photosensitive elements such as photodiodes that convert the incoming light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the image pixels and readout circuitry for reading out image signals corresponding to the electric charge generated by the photosensitive elements.

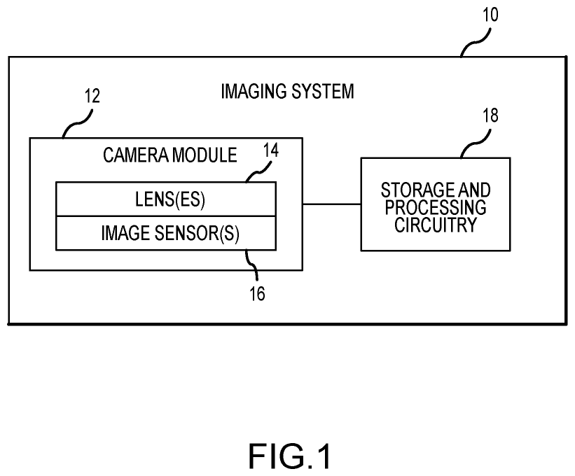

FIG. 1 is a diagram of an illustrative imaging system such as an electronic device that uses an image sensor to capture images. Electronic device 10 of FIG. 1 may be a portable electronic device such as a camera, a cellular telephone, a tablet computer, a webcam, a video camera, a video surveillance system, an automotive imaging system, a video gaming system with imaging capabilities, or any other desired imaging system or device that captures digital image data. Camera module 12 may be used to convert incoming light into digital image data. Camera module 12 may include one or more lenses 14 and one or more corresponding image sensors 16. Lenses 14 may include fixed and/or adjustable lenses and may include microlenses formed on an imaging surface of image sensor 16. During image capture operations, light from a scene may be focused onto image sensor 16 by lenses 14. Image sensor 16 may include circuitry for converting analog pixel data into corresponding digital image data to be provided to storage and processing circuitry 18. If desired, camera module 12 may be provided with an array of lenses 14 and an array of corresponding image sensors 16.

Storage and processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18 (e.g., using an image processing engine on processing circuitry 18, using an imaging mode selection engine on processing circuitry 18, etc.). Processed image data may, if desired, be provided to external equipment (e.g., a computer, external display, or other device) using wired and/or wireless communications paths coupled to processing circuitry 18.

In accordance with an embodiment, imaging system 10 is provided that is capable of both capturing scene images and depth information using the same sensor 16 (e.g., using only a subset of the entire array of image sensor pixels to measure the depth of selected regions in the scene). Doing so helps to align the depth information with the scene information, and also reduces system cost by not having to implement a separate specialized sensor for depth measurements.

Die stacking may be leveraged to allow the pixel array to connect to corresponding region of interest (ROI) processors to enable time-of-flight (TOF) measurements with no changes to the existing pixel circuitry. For example, the disclosed depth detection techniques leverage circuit schemes with modest speed requirements to achieve 100 picosecond time resolution range. If desired, the TOF information is coupled with some rough knowledge of scene depth that is then used to refine the timing for the final depth measurement of objects. The TOF measurements can be performed at a single pixel higher resolution mode or on groups of pixels at lower resolution. The groups of pixels can be arranged in arbitrary patterns for detecting depth of particular features/shapes or be used with rectangular macro-pixel patterns to improve light sensitivity. This process may be performed in parallel for multiple regions of interest (ROIs) without interrupting normal pixel array readout. This technique may also be extended to conventional image sensors without ROI processing for higher resolution depth sensing.

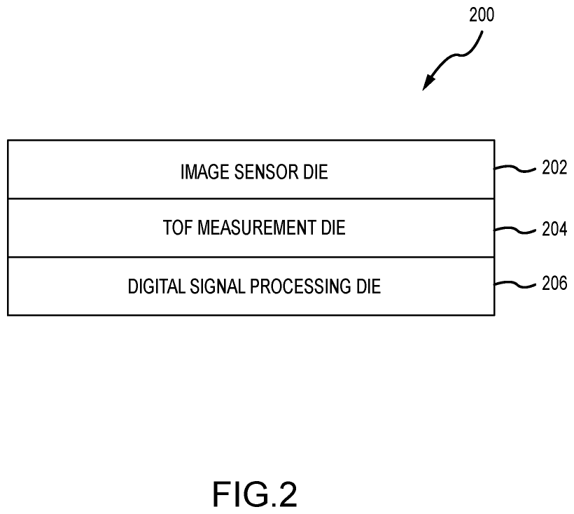

FIG. 2 is a diagram of an illustrated stacked imaging system 200. As shown in FIG. 2, system 200 may include an image sensor die 202 as the top die, a digital signal processor die 206 as the bottom die, and TOF measurement die 204 that is stacked vertically between top die 202 and bottom die 206. The array of image sensor pixels reside solely within the top image sensor die 202; the normal digital readout circuits reside within the bottom die 206; and the depth sensing circuitry (sometimes referred to as time-of-flight measurement circuitry or distance measurement circuitry) is formed within the middle die 204. If desired, other ways of stacking the various imager dies may also be used.

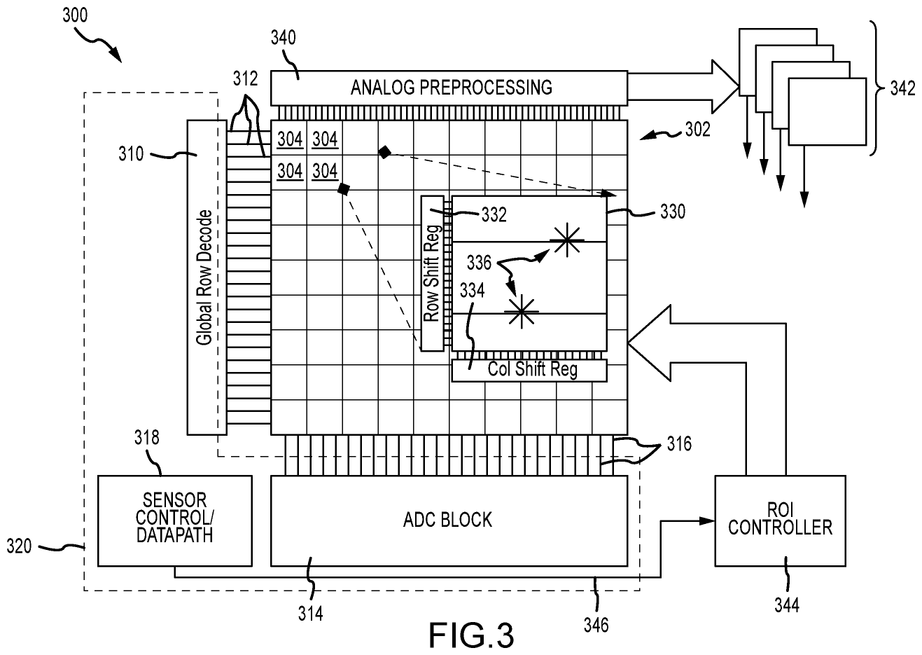

FIG. 3 is a diagram of an illustrative image sensor array 302 coupled to digital processing circuits and time-of-flight (TOF) measurement circuits. The digital signal processing circuits are delineated by dotted box 320, which include a global row decoder 310 configured to drive all the pixel rows within array 302 via row control lines 312, an analog-to-digital converter (ADC) block 314 configured to receive pixels values via each pixel column through the normal readout paths 316, and a sensor controller 318. These digital signal processing circuits 320 may reside within the bottom die 206 (see FIG. 2).

The image pixel array 302 may be formed on the top image sensor die 202. Pixel array 302 may be organized into groups sometimes referred to as “tiles” 304. Each tile 304 may, for example, include 256×256 image sensor pixels. This tile size is merely illustrative. In general, each tile 304 may have a square shape, a rectangular shape, or an irregular shape of any suitable dimension (i.e., tile 304 may include any suitable number of pixels).

Each tile 304 may correspond to a respective “region of interest” (ROI) for performing TOF measurement. A separate ROI processor 330 may be formed in the intermediate die 204 below each tile 304. Each ROI processor 330 may include a row shift register 332, a column shift register 336, and row control and switch matrix circuitry for selectively combining the values from multiple neighboring pixels, as represented by converging lines 336. Signals read out from each ROI processor 330 may be fed to analog processing and multiplexing circuit 340 and provided to circuits 342. Circuits 342 may include analog filters, comparators, high-speed ADC arrays, etc. Sensor control 318 may send signals to ROI controller 344, which controls how the pixels are read out via the ROI processors 330. For example, ROI controller 344 may optionally control pixel reset, pixel charge transfer, pixel row select, pixel dual conversion gain mode, a global readout path enable signal, a local readout path enable signal, switches for determining analog readout direction, ROI shutter control, etc. Circuits 330, 340, 342, and 344 may all be formed within the analog die 204.

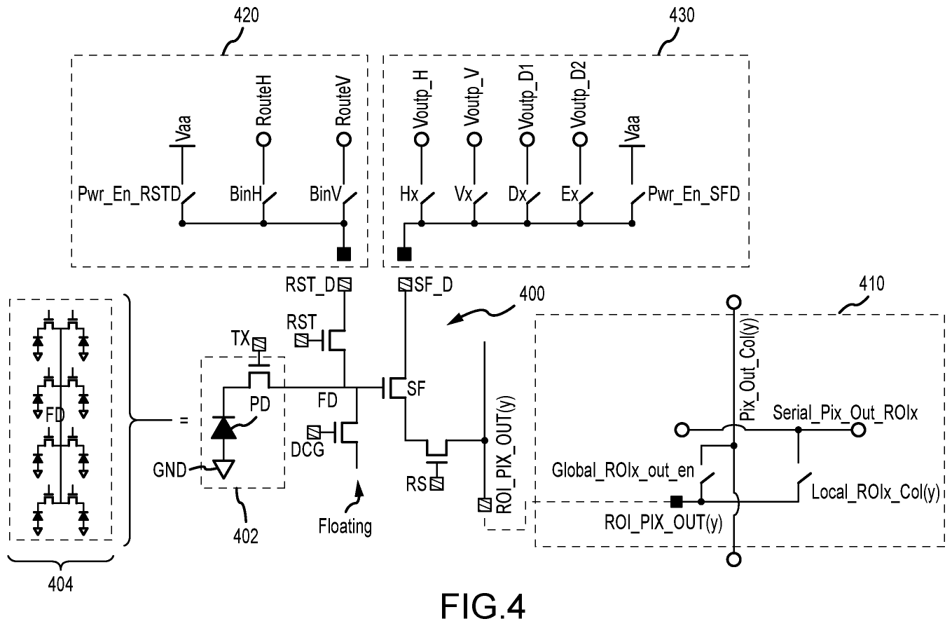

FIG. 4 is a diagram showing how an image pixel may be connected to a particular region of interest (ROI) via various switch networks. As shown in FIG. 4, an image sensor pixel such as pixel 400 may include a photodiode PD coupled to a floating diffusion node FD via a charge transfer transistor, a reset transistor coupled between the FD node and a reset drain node RST_D (sometimes referred to as a reset transistor drain terminal), a dual conversion gain (DCG) transistor having a first terminal connected to the FD node and a second terminal that is electrically floating, a source follower transistor with a drain node SF_D, a gate terminal connected to the FD node, and a source node coupled to the ROI pixel output line via a corresponding row select transistor. If desired, the DCG switch may optionally be coupled to a capacitive circuit (e.g., a fixed capacitor or a variable capacitor bank) for charge storage purposes or to provide additional gain capabilities. Portion 402 of pixel 400 may alternatively include multiple photodiodes that share a single floating diffusion node, as shown by configuration 404.

In one suitable arrangement, each reset drain node RST_D within an 8×8 pixel cluster may be coupled to a group of reset drain switches 420. This is merely illustrative. In general, a pixel cluster that share switches 420 may have any suitable size and dimension. Switches 420 may include a reset drain power enable switch that selectively connects RST_D to positive power supply voltage Vaa, a horizontal binning switch BinH that selectively connects RST_D to a corresponding horizontal routing line RouteH, a vertical binning switch BinV that selectively connects RST_D to a corresponding vertical routing line RouteV, etc. Switch network 420 configured in this way enables connection to the power supply, binning charge from other pixels, focal plane charge processing.

Each source follower drain node SF_D within the pixel cluster may also be coupled to a group of SF drain switches 430. Switch network 430 may include a SF drain power enable switch Pwr_En_SFD that selectively connects SF_D to power supply voltage Vaa, switch Hx that selectively connects SF_D to a horizontal line Voutp_H, switch Vx that selectively connects SF_D to a vertical line Voutp_V, switch Dx that selectively connects SF_D to a first diagonal line Voutp_D1, switch Ex that selectively connects SF_D to a second diagonal line Voutp_D2, etc. Switches 430 configured in this way enables the steering of current from multiple pixel source followers to allow for summing/differencing to detect shapes and edges and connection to a variable power supply.

Each pixel output line ROI_PIX_OUT(y) within the pixel cluster may also be coupled to a group of pixel output switches 410. Switch network 410 may include a first switch Global_ROIx_out_en for selectively connecting the pixel output line to a global column output bus Pix_Out_Col(y) and a second local switch Local_ROIx_Col(y) for selectively connecting the pixel output line to a local ROI serial output bus Serial_Pix_Out_ROIx that can be shared between different columns. Configured in this way, switches 410 connects each pixel output from the ROI to one of the standard global output buses for readout, to a serial readout bus to form the circuit used to detect shapes/edges, to a high speed local readout signal chain, or to a variable power supply.

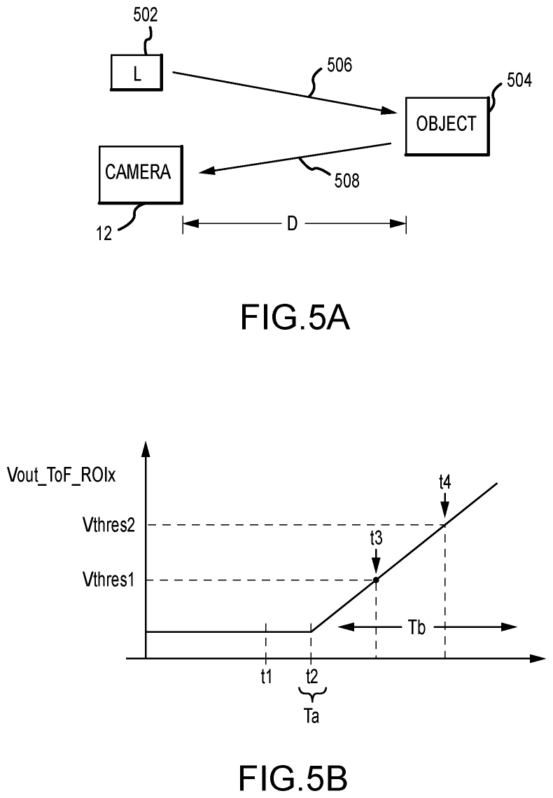

FIG. 5A is a diagram showing camera module 12 that is configured to obtain time-of-flight (TOF) measurements. As shown in FIG. 5A, a light source such as a beam steering laser 502 may emit light 506 (e.g., a 100 ps light pulse, a point spot, or a flash blanket illumination) towards an external object 504. Although laser 502 is shown as a separate component, laser 502 may optionally be formed as part of camera module 12. The external object 504 may be disposed a distance D away from camera 12. The light 506 emitted from laser 502 may reflect off object 504 and travel back towards camera 12 (see reflected light 508). The total amount of time for the emitted light 506 to travel to object 504 and for the reflected light 508 to travel from object 504 back to camera 12 is referred to as the time-of-flight (TOF) measurement and can then be used to compute a measured distance.

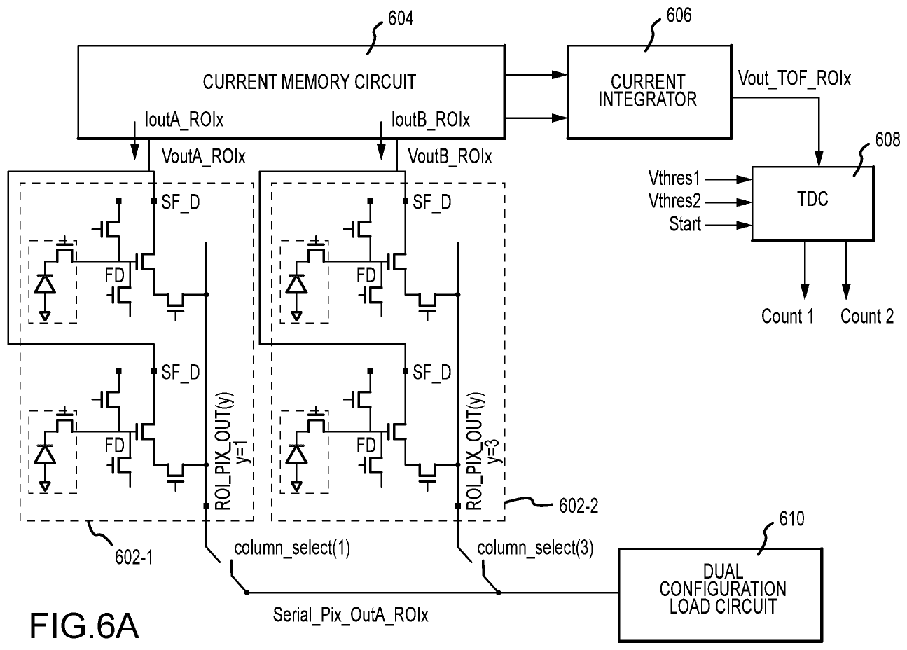

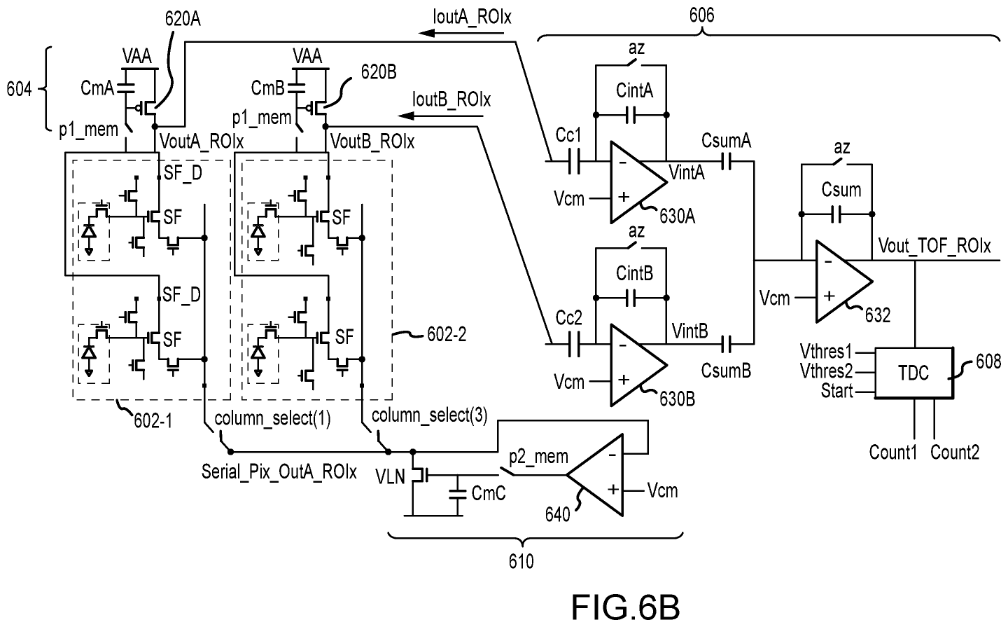

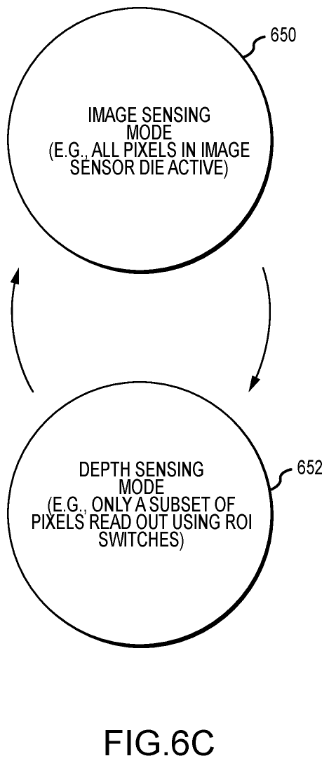

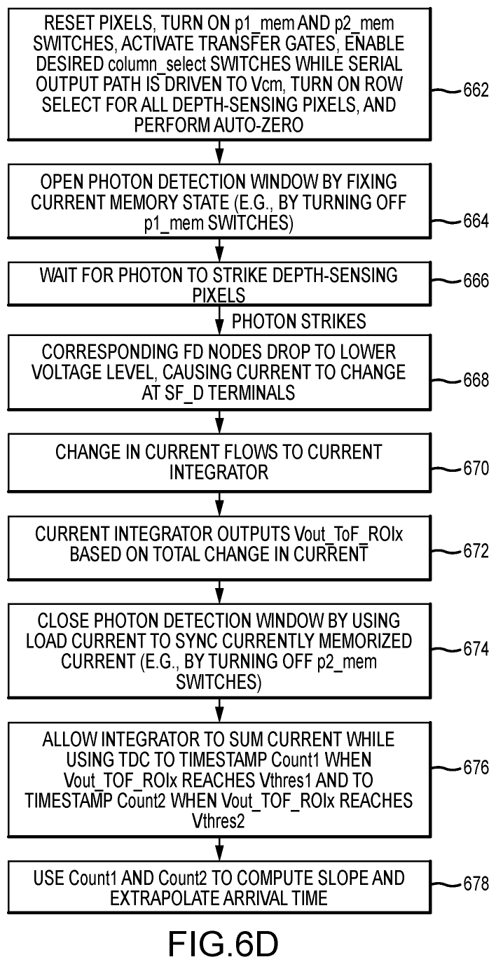

FIG. 5B is a timing diagram illustrating the high-level operation of camera module 12 to compute a TOF measurement. The laser pulse may be fired at time t1. Individual pixels or groups of pixels may be enabled for a duration Ta (e.g., 1-10 ns time slots) within a 1-2 us range window to capture the reflected laser pulse. The time slot may be enabled based on estimated distance of object from a previous scene analysis (either from previous laser pulses or other signal processing for depth estimation). The photon may arrive within duration Ta at time t2 within the 1-10 ns time slot. (sometimes referred to as depth measurement circuitry, distance measurement circuitry, or depth sensing circuitry) to account for multiple photon events at different times during the photon acquisition window, or any suitable number of threshold levels can be used to acquire multiple timestamps for extrapolating an accurate return time. Additional details of operation will become clearer by referring to the pixel configuration of FIGS. 6A and 6B.

FIG. 6A is top level diagram of illustrative pixel circuitry configured to enable TOF measurements in accordance with an embodiment. As shown in FIG. 6A, pixels in a first pixel group 602-1 (in column y=1) may have source follower drain nodes SF_D on which a first output signal VoutA_ROIx is routed to current memory circuit 604 using associated ROI switches (e.g., using ROI switches 430 in FIG. 4), whereas pixels in a second pixel group 602-2 (in column y=3) may have SF_D nodes on which a second output signal VoutB_ROIx is routed to current memory 604 using associated ROI switches. In other words, the SF_D nodes in two pixels of column y=1 may be shorted together using associated ROI switches, whereas the SF_D nodes in the two pixels of column y=3 may be separately shorted together using associated ROI switches associated with those pixels. The pixel structure shown within the dotted lines may be formed as part of top image sensor die 202, whereas the remaining circuitry outside of the dotted boxes such as circuits 604, 606, 608, and 610 may be formed as part of the intermediate TOF measurement die 204 and may sometimes be referred to collectively as depth sensing circuitry or TOF measurement circuitry. The current memory circuit 604 may be coupled to a current integrator circuit 606 (e.g., a current summing circuit), which is configured to output a corresponding signal Vout_TOF_ROIx to a counter such as time-to-digital converter (TDC) 608. Converter 608 may be controlled by signals V_thres1, Vthres2, and Start, and may generate corresponding output Count1 and Count2.

The pixel output lines of each pixel group may be coupled to a dual configuration load circuit 610 via serial output bus Serial_Pix_OutA_ROIx. For example, the first pixel output line ROI_PIX_OUT(1) may be selectively coupled to the serial output bus via a first column selection switch column_select(1), whereas the third pixel output line ROI_PIX_OUT(3) may be selectively coupled to the serial output bus via another column selection switch column_select(2). The column_select switches may (for example) correspond to the local ROI switch shown in 410 of FIG. 4 and may also be formed in the intermediate TOF measurement die. Dual configuration load circuit 610 may be configured in either a first mode to provide a common mode voltage on the serial output bus or in a second mode to serve as current memory that supplies a stored current.

FIG. 6B is a circuit diagram illustrating one suitable implementation of the pixel circuitry of FIG. 6A. As shown in FIG. 6B, current memory 604 may be implemented using p-type transistors (e.g., p-channel transistors), capacitors, and associated memory switches. For instance, the SF_D terminals in the first pixel group may be coupled to power supply VAA via a first p-type transistor 620A having a first storage capacitor CmA connected across its source and gate terminals and a memory switch p1_mem connected across its drain and gate terminals. Similarly, the SF_D terminals in the second pixel group may be coupled to power supply VAA via a second p-type transistor 620B having a second storage capacitor CmB connected across its source and gate terminals and another memory switch p1_mem connected across its drain and gate terminals. When switches p1_mem are turned on, any change in voltage VoutA_ROIx will be memorized on capacitor CmA and any change in voltage VoutB_ROIx will be memorized on capacitor CmB. When switches p1_mem are turned off, constant current is held through the p-type transistors since the voltage across storage capacitors CmA/CmB cannot change.

A first current signal IoutA_ROIx may flow between the drain terminal of current memory transistor 620A and a first input of current integrator 606, whereas a second current signal IoutB_ROIx may flow between the drain terminal of current memory transistor 620B and a second input of current integrator 606. Current integrator 606 may include a first stage of amplifiers 630A and 630B. Amplifier 630A may have a first (positive) input terminal configured to receive a common mode voltage Vcm, a second (negative) input terminal configured to receive VoutA_ROIx via first coupling capacitor Cc1, an output on which first integrating voltage VintA is provided, a first integrating capacitor CintA coupled across its negative input terminal and its output, and a first autozero switch coupled across its negative input terminal and its output. Similarly, amplifier 630B may have a first (+) input terminal configured to receive Vcm, a second (−) input terminal configured to receive VoutB_ROIx via second coupling capacitor Cc2, an output on which second integrating voltage VintB is provided, a second integrating capacitor CintB coupled across its negative input terminal and its output, and a second autozeroing switch coupled across its negative input terminal and its output. Arranged in this way, amplifier 630A is configured to sense a first amount of change/delta in IoutA_ROIx caused by the return photon (denoted by ΔIoutA), whereas amplifier 630B is configured to sense a second amount of change/delta in IoutB_ROIx caused by the return photon (denoted by ΔIoutB).

Current integrator 606 may further include a second amplifier stage 632. Amplifier 632 may have a first (+) input terminal configured to receive Vcm, a second (−) input terminal configured to receive VintA via first summing capacitor CsumA and to receive VintB via a second summing capacitor CsumB, an output on which depth sensing output voltage Vout_TOF_ROIx is generated, a third integrating capacitor Csum coupled across its negative input terminal and its output, and a third autozeroing switch coupled across its negative input terminal and its output. Voltage Vout_TOF_ROIx generated by integrator 606 in this way will be proportional to the sum of ΔIoutA and ΔIoutB and may be fed to TDC 608 to determine a first count value Count1 (e.g., a first timestamp) when Vout_TOF_ROIx reaches the first threshold level Vthres1 and to determine a second count value Count2 (e.g., a second timestamp) when Vout_TOF_ROIx reaches the second threshold level Vthres2.

Still referring to FIG. 6B, dual configuration load circuit 610 may include amplifier 640 (e.g., a high bandwidth amplifier arranged in unity gain configuration) having a negative (−) input terminal connected to the ROI serial output bus, a positive (+) input terminal configured to receive common mode voltage Vcm, and an output that is selectively coupled to the gate terminal of n-type transistor current source device VLN via switch p2_mem. Storage capacitor CmC is also connected to the gate terminal of transistor VLN in a shunt configuration. N-type transistor current source device VLN, when activated, serves to supply a current sink to the ROI serial output bus that flows to ground. When switch p2_mem is turned on, the SF_D nodes outputs a variable current based on the voltages on the floating diffusion nodes and based on the pixel output line that is driven to Vcm by amplifier 640 in the unity gain configuration. When switch p2_mem is turned off, the SF_D nodes output current that follows the floating diffusion voltage, and the combined current flowing through the VLN device will be memorized at that instant since the voltage at the gate of transistor VLN can no longer change after the p2_mem is shut off.

As described above in connection with FIG. 5B, the circuitry of FIG. 6B may be configured to capture photon events that occur only in a designated time slot Ta between p1_mem turning off (which sets the start of the time slot) and p2_mem turning off (which sets the end of the time slot). The first stage amplifiers 630A/B connected to the SF_D path integrate current over a longer integration time Tb generated in response to that photon event. The integrator may reject photon events detected outside the time slot. The summing amplifier 632 will then trigger a TDC 608, which outputs values that can be used to derive when the event has occurred.

Configured in this way, the pixels generate change in the current signals at the output of the source follower drain nodes SF_D in response capturing the laser pulse reflected photons. The current is subsequently integrated in the integrator circuit to generate a voltage Vout_TOF_ROIx that drives TDC 608. The TOF measuring circuitry may be optionally enabled along with normal image capture using the stacked die architecture dedicated readout paths to allow simultaneously capturing depth information. In particular, the TDC 608 may be triggered at times t3 and t4 (see FIG. 5B) or more to measure the slope of the integrator output Vout_TOF_ROIx. This measured slope may then be used to determine the time for photon return event and the number of return electrons captured.

In other words, the circuitry of FIG. 6B uses the pixel high conversion gain and the source follower transconductance to generate a current that is linearly proportional to electrons collected at the floating diffusion node (e.g., the source follower current is used to generate a linear voltage ramp). The TOF measurement is performed by checking for the return signal within a small time window Ta (e.g., a 1-10 ns window or longer), and the resulting signal is used to determine a more precise time within that window. Time stamps are captured by the time-to-digital converter 608 as its passes selected voltage thresholds, and the time counters can be used to calculate the ramp slope to extrapolate when the photon was actually captured by the pixel. The magnitude of the slope is also proportional to the amount of electrons collected. Thus, both arrival time and the magnitude of the return signal may be computed in this way.

Rather than trying to drive the TX gate at high speed to check for the return signal during a particular time window, the circuit relies on the peripheral current memory circuits (e.g., current mirroring or current copier cells) that enable detection of the floating diffusion level changes within short time intervals. Because the current copier cells are in the periphery of the array and individually programmable, multiple time windows within the same row or column can be checked simultaneously to allow for checking spatially separated objects at different depths (e.g., using laser flash illumination). If desired, multiple pixels may be connected together to improve sensitivity while trading off resolution. The ROI architecture reduces loading on critical output lines to allow improved time resolution.

FIG. 6C is a diagram illustrating how the imaging circuitry may be operable in an image sensing mode 650 and a depth sensing mode 652. When operated in the image sensing mode 650, all of the pixels (or at least a large portion of pixels) in the image sensor array on the top die may be activated to image the scene. When operated in the depth sensing mode 652, only a subset of pixels may be selected for TOF measurement readout using the ROI switches in the middle stacked die. Using the ROI circuitry to select regions for depth sensing enables use of small high precision circuits (e.g., small but precise current memory 604, current integrator 606, converter 608, and load circuit 610) without the power that is otherwise needed to process the entire sensor. The example of FIG. 6C where the imaging circuitry is operated in either mode 650 or mode 652 is merely illustrative. If desired, modes 650 and 652 can occur simultaneously to read out scene signals from the entire image sensor array and to generate TOF information from a relatively smaller group of pixels in parallel.

FIG. 6D is a flow chart of illustrative steps for operating image pixel circuitry of the type shown in FIG. 6A-6B to perform depth sensing. At step 662, a selected group of pixels may be reset, current memory circuit 604 may be turned on by activating the p1_mem switches, load circuit 610 may be configured in Vcm driving mode by activating the p2_mem switch, the transfer (TX) gates in the selected group of pixels may be activated to allow any accumulated charge to flow directly to the respective floating diffusion nodes, the appropriate column_select switches (see FIGS. 6A and 6B) may be enabled to allow amplifier 640 to drive the column lines to Vcm, the row select (RS) transistor in the selected group of depth sensing pixels may be turned on, and autozeroing operations may be initiated (e.g., by turning on switches az for amplifiers 630A, 630B, and 632).

At step 664, the photon detection window may be opened (i.e., to set/trigger the leading edge of time slot Ta in FIG. 5B) by fixing the state of current memory circuit 604 (e.g., by turning off the p1_mem switches). When the p1_mem switches are off, the reset current levels will be memorized on the current memory storage capacitors CmA and CmB and cannot change as long as p1_mem remains in the off state. In other words, the current memory circuit is configured as a fixed current source.

At step 666, the depth-sensing pixels may wait for one or more photons to strike during the photon detection window. When a photon strikes a photodiode, the photodiode may generate an electron, which can then flow to the corresponding floating diffusion node to cause the FD node to drop to a lower voltage level. When the voltage at a FD region decreases, the amount of current being drawn from the corresponding SF_D terminal will change.

This change in current will be detected by integrator circuit 606 (at step 670). At step 672, the integrator circuit 606 may drive Vout_TOF_ROIx based on the total change in current (e.g., based on the current delta seen in IoutA_ROIx and IoutB_ROIx).

At step 674, the photon detection window is closed (i.e., to set/trigger the trailing edge of time slot Ta in FIG. 5B) by using the load circuit to sink a presently memorized current (e.g., by turning off the p2_mem switch). When the p2_mem switch is turned off, load circuit 610 is configured in a current memory mode and whatever current flowing through pull-down transistor VLN at that time will be memorized by storage capacitor CmC and cannot change as long as p2_mem remains in the off state. In other words, the load circuit is configured as a fixed current sink.

At step 676, integrator circuit 606 may be used to sum the current changes detected in IoutA_ROIx and IoutB_ROIx. As the current change is integrated in circuit 606, output voltage Vout_TOF_ROIx may gradually increase. Time-to-digital converter 608 may generate a first timestamp value Count1 whenever Vout_TOF_ROIx reaches or exceeds first predetermined threshold Vthres1 and may further generate a second timestamp value Count2 whenever Vout_TOF_ROIx reaches or exceeds second predetermined threshold Vthres2. As an example, Vthres1 may be set at around 25% of the possible voltage swing in Vout_TOF_ROIx, and Vthres2 may be set at around 75% of the possible voltage swing in Vout_TOF_ROIx. As another example, Vthres1 may be set at around 10% of the possible voltage swing in Vout_TOF_ROIx, and Vthres2 may be set at around 90% of the possible voltage swing in Vout_TOF_ROIx. As yet another example, Vthres1 may be set at around 40% of the possible voltage swing in Vout_TOF_ROIx, and Vthres2 may be set at around 60% of the possible voltage swing in Vout_TOF_ROIx. In general, the thresholds may be set at any predetermined threshold amount for accurate computation of the rate at which Vout_TOF_ROIx ramps up during time Tb (see FIG. 5B).

At step 678, the imaging circuitry may use the timestamp values Count1 and Count2 to compute to slope of the Vout_TOF_ROIx ramp and may then extrapolate a more precise arrival time based on the computed slope. The arrival time computed in this way can then be used to determine an accurate distance between the camera module and the measured object.

Although the methods of operations are described in a specific order, it should be understood that other operations may be performed in between described operations, described operations may be adjusted so that they occur at slightly different times or described operations may be distributed in a system which allows occurrence of the processing operations at various intervals associated with the processing, as long as the processing of the overlay operations are performed in a desired way.

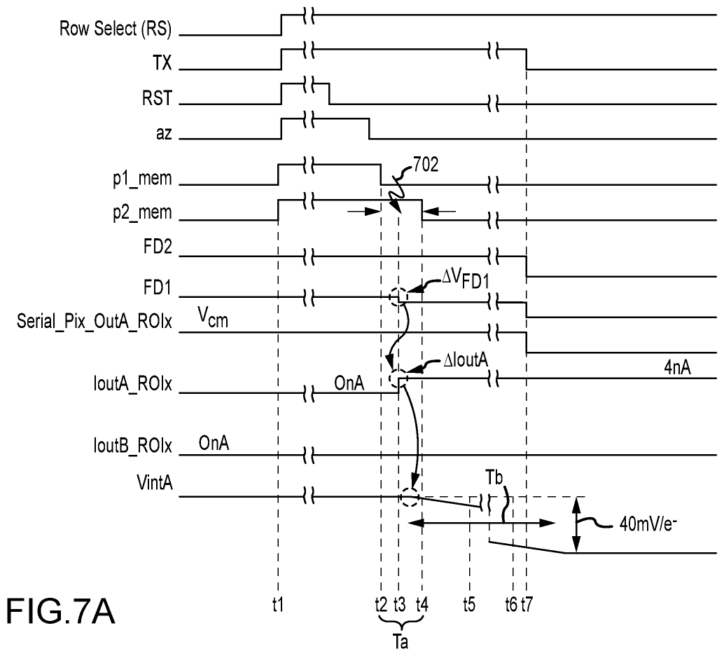

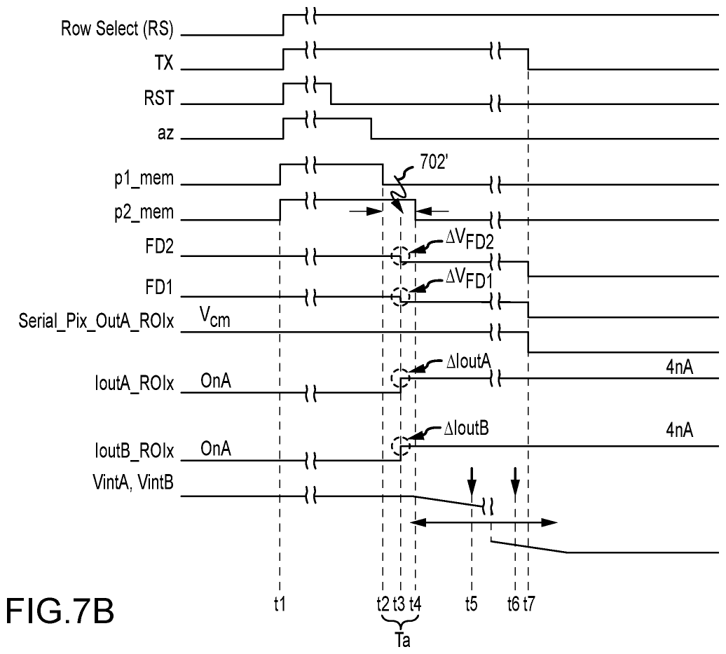

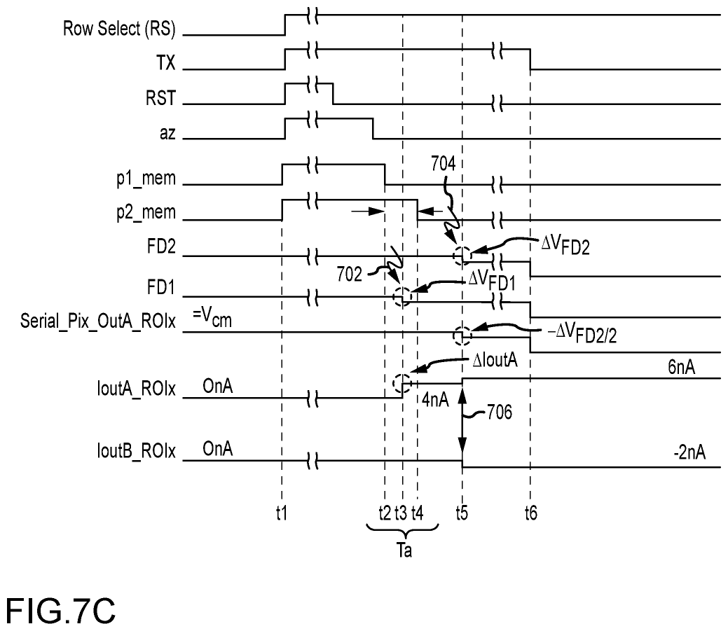

FIG. 7A is a timing diagram illustrating the operation of the pixel circuitry of the type shown in FIG. 6B when a single photon strikes one of the pixels among a group of pixels selected for depth sensing (sometimes collectively referred to as depth-sensing pixels). Time t1 corresponds to step 662 of FIG. 6D, when the row select transistors, charge transfer gates, reset gates, autozero switches, and p1_mem/p2_mem switches are all turned on. In the example of FIG. 7A, an incident photon 702 causes FD1 to change by ΔV_{FD1} at time t3 within small time slot Ta (between time t2 and t4). The voltage perturbation at FD1 will cause a corresponding current change in IoutA_ROIx (see ΔIoutA of 4 nA as an example assuming a single electron is detected). The current change in IoutA_ROIx may then cause VintA to start decreasing, which would cause Vout_TOF_ROIx (not shown in FIG. 7A) to start ramping up. The TDC may record timestamps at time t5 (when Vout_TOF_ROIx reaches Vthres1) and at time t6 (when Vout_TOF_ROIx reaches Vthres2). The depth sensing operation may terminate at time t7, when the TX gates are turned off and serial output bus is cut off. The TX signal going low may be coupled to FD1 and FD2 by the same amount, so there is no output current change. In the example of FIG. 7A, a single electron may induce a drop in VintA of 40 mV. If more electrons are generated, VintA may drop by some multiple of 40 mV (as an example), which would cause Vout_TOF_ROIx to ramp up faster.

FIG. 7B is a timing diagram illustrating a scenario when two photons strike two different pixels in a group of depth-sensing pixels. Time t1 corresponds to step 662 of FIG. 6D, when the row select transistors, charge transfer gates, reset gates, autozero switches, and p1_mem/p2_mem switches are all turned on. In the example of FIG. 7B, incident photons 702′ cause FD1 to change by ΔV_{FD1} and FD2 to change by ΔV_{FD2} at time t3 within small time slot Ta (between time t2 and t4). The voltage perturbation at FD1 and FD2 will cause corresponding current change in IoutA_ROIx and IoutB_ROIx (see ΔIoutA of 4 nA and ΔIoutB of 4 nA as an example). The current change in IoutA_ROIx and IoutB_ROIx may then cause VintA and VintB to start decreasing, which would cause Vout_TOF_ROIx (not shown in FIG. 7B) to start ramping up at a faster rate than that of FIG. 7A since two photons are detected. The TDC may record timestamps at time t5 (when Vout_TOF_ROIx reaches Vthres1) and at time t6 (when Vout_TOF_ROIx reaches Vthres2). The depth sensing operation may terminate at time t7, when the TX gates are turned off and serial output bus is cut off.

FIG. 7C is a timing diagram illustrating a scenario when charge is detected during a designated time slot and how charge detected outside of the time slot is not taken into account (i.e., additional photons striking the image sensor pixels outside the photon detection window may be rejected so that the computed time of arrival is not affected by the additional photons). Time t1 corresponds to step 662 of FIG. 6D, when the row select transistors, charge transfer gates, reset gates, autozero switches, and p1_mem/p2_mem switches are all turned on. In the example of FIG. 7C, incident photon 702 causes FD1 to change by ΔV_{FD1} within small time slot Ta (between time t2 and t4). The voltage perturbation at FD1 will cause corresponding current change in IoutA_ROIx (see ΔIoutA of 4 nA as an example). At time t4, the p2_mem switch is turned off, which closes the photon detection window. In the example of FIG. 7C, another photon 704 may cause FD2 to drop at time t5. Since the load circuit is supplying a fixed current at this point, a corresponding increase in IoutA_ROIx will be offset by an equivalent decrease in IoutB_ROIx (see arrow 706). As a result, the net current change at the output is zero for electrons collected outside the designed time slot Ta (i.e., the TDC operation will not be impacted by additional photon strikes occurring outside Ta). The depth sensing operation may terminate at time t7, when the TX gates are turned off and serial output bus is cut off.

Several features are illustrated by these timing diagrams. As described above, the current memory circuit 604 allows storing the initial state of the pixel source follower current that is set by the initialized floating diffusion voltage and source voltage at some point in time that guarantees proper circuit settling. The p1_mem switches can be turned off at a precise time, at which point the current that is supplied to the pixel source follower drain terminal by circuit 604 will be fixed.

Load current 610 may drive the pixel source follower “source” voltage to common mode voltage Vcm during initialization (putting the pixel source follower transistor into a “common source amplifier” configuration) and during the photon return signal acquisition time slot. Load circuit 610 is also simultaneously sampling the combined current flowing through the pixel source follower devices. This load current may change rapidly through the source follower with the source held at Vcm and as electrons decrease the voltage on the floating diffusion (FD) node capacitance. The amplifier 640 in the load circuit is used to track the current change within the desired time resolution for the TOF measurement while holding the source at Vcm. Smaller capacitance loads on the pixel readout bus enabled by the local readout bus for the ROI control architecture make the design of the amplifier lower power and faster.

Because the current memory 604 holds the initialized source follower drain current value, the pixel source follower current changes flow out of the pixel circuit to the integrator if electrons are collected on the floating diffusion during the acquisition time slot Ta. The load circuit 610 may be switched from the Vcm voltage source to the stored current source sink value when the acquisition time slot ends. Switch p2_mem can be turned off at a precise time. Because the tracked current is stored on the VLN current sink device, the change in pixel source follower current may continue to flow out of the circuit at a constant value to the integrator to generate the linear ramp. The current value remains constant even if more electrons are collected on the pixel floating diffusion node after the acquisition time slot ends.

Any current change through the source follower device during the designated acquisition time slot Ta (e.g., current change caused by electron collected on the FD node) may be directed to current integrator 606. Integrator circuit 606 may integrate the detected current change to generate voltage Vout_TOF_ROIx that drives into TDC 608 and generates time counts as thresholds are crossed. The slope of this line may be used to determine when the electrons were generated.

As described above, the ROI architecture can help reduce loading the pixel output line (using local/serial bus routing) while also enabling connecting pixel outputs together in flexible configurations to allow checking for depth of rectangular-shaped macropixels or for checking different shaped features.

The embodiments of FIGS. 6A and 6B where current integrator 606 is configured to integrate current from two different SF_D paths (e.g., a first path on which VoutA_ROIx is provided and a second path on which VoutB_ROIx is provided) are merely illustrative and are not intended to limit the scope of the present embodiments. If desired, current integrator 606 may be optionally configured to detect a current delta in only one SF_D output path, to detect current deltas from three or more separate SF_D output paths, or to detect current changes among any suitable number of source follower drain nodes.

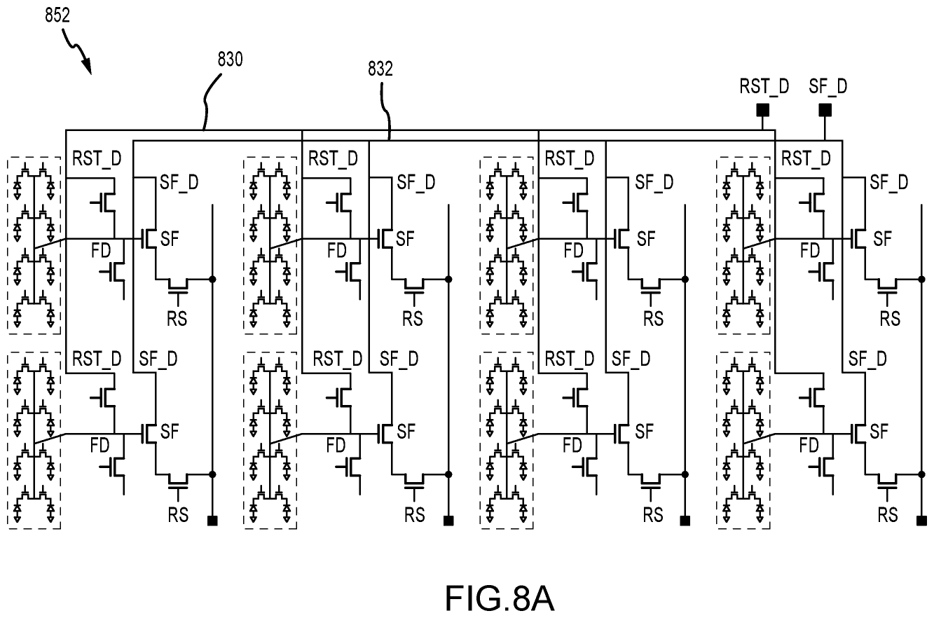

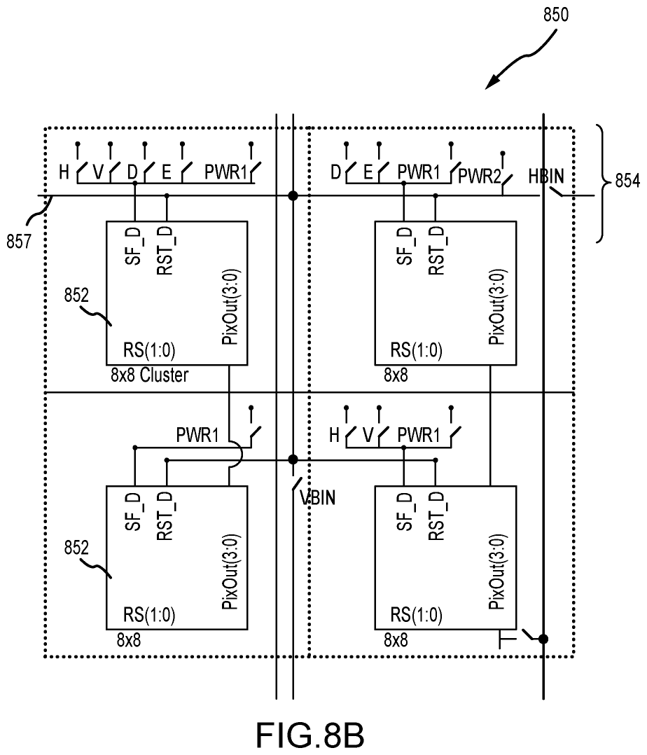

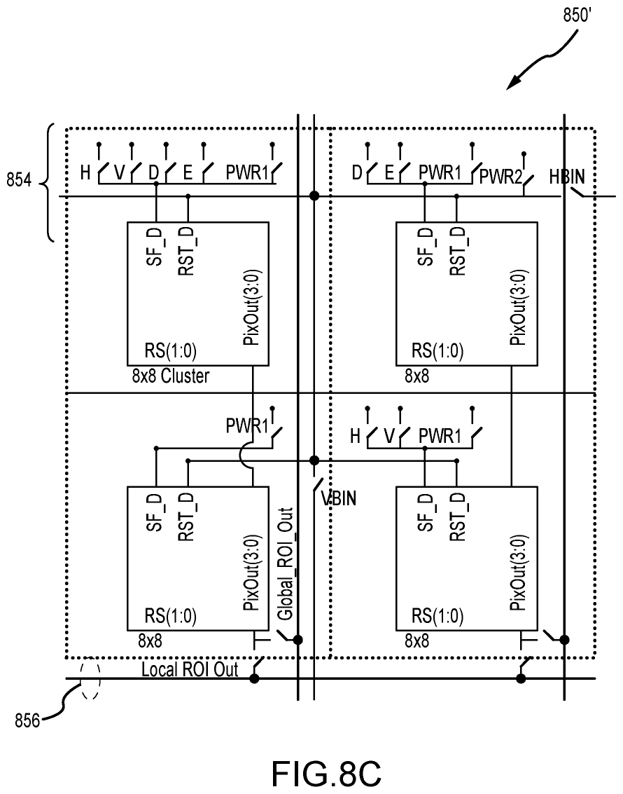

FIG. 8A is a diagram of an illustrative 8×8 pixel cluster 852. A shown in FIG. 8A, the RST_D nodes of each image pixel in the cluster are interconnected via a reset drain coupling path 830 (e.g., using one of switches 420 in FIG. 4), whereas the SF_D nodes of each image pixel in the cluster are interconnected via a source follower drain coupling path 832 (e.g., using one of switches 430 in FIG. 4). The RST_D terminals may be selectively shorted together to perform charge binning (e.g., the RST_D nodes of pixels along the same row may be coupled together to perform horizontal binning and/or the RST_D nodes of pixels along the same column may be coupled together to perform vertical binning). On the other hand, the SF_D terminals may be selectively shorted together to perform TOF measurements as described in connection with FIGS. 5-7.

FIG. 8B is a diagram of an illustrative ROI unit cell 850. In the example of FIG. 8B, each ROI unit cell 850 may include four 8×8 pixel clusters 852 that share the various switch networks described in connection with FIG. 4A. In the example of FIG. 8B, each cluster 852 may have a different number of SF_D switches. For example, the top left cluster may be coupled to five SF_D switches while the top right cluster may only be coupled to three SF_D switches. This is merely illustrative. If desired, each cluster 852 may be coupled to any suitable number of SF_D switches.

The four pixel clusters 852 within ROI unit cell 850 may have the RST_D terminals coupled together via path 857. Configured in this way, the four pixel clusters in cell 850 may be coupled to the pixel clusters in a neighboring ROI cell column by selectively turning on a horizontal binning switch HBIN and/or may be coupled to the pixel clusters in a neighboring ROI cell row by selectively turning on a vertical binning switch VBIN. The vertical/horizontal binning switches may be formed in the intermediate die 204 (FIG. 2).

FIG. 8C is a diagram of another ROI cell 850′ that can be formed at the bottom of each ROI cell column. As shown in FIG. 8C, ROI cell 850′ may be configured to route the pixel output from the ROI cell to a global pixel output bus Global_ROI_Out or to a common local/serial output line Local_ROI_Out (see local serial output line 856).

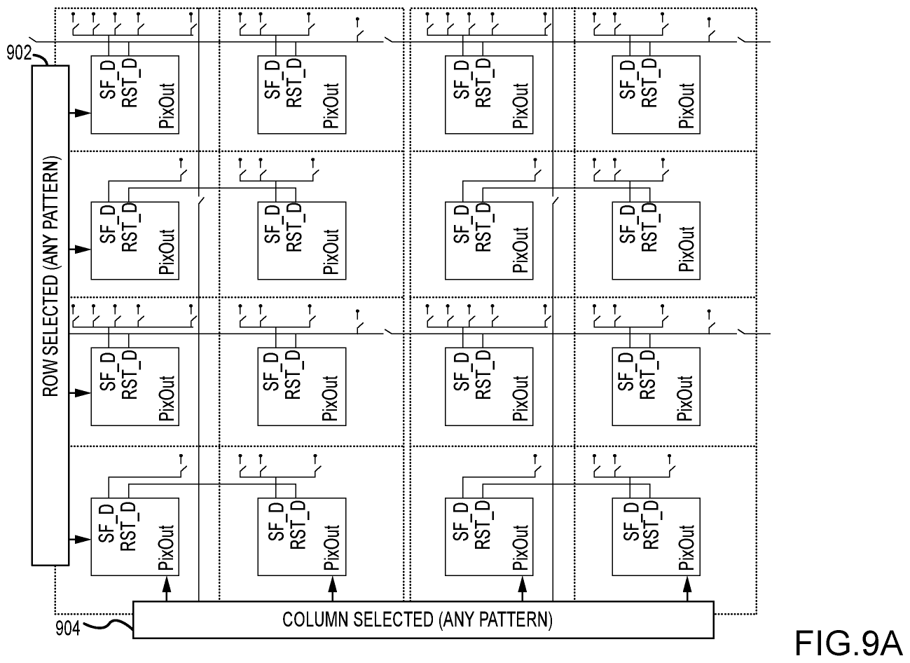

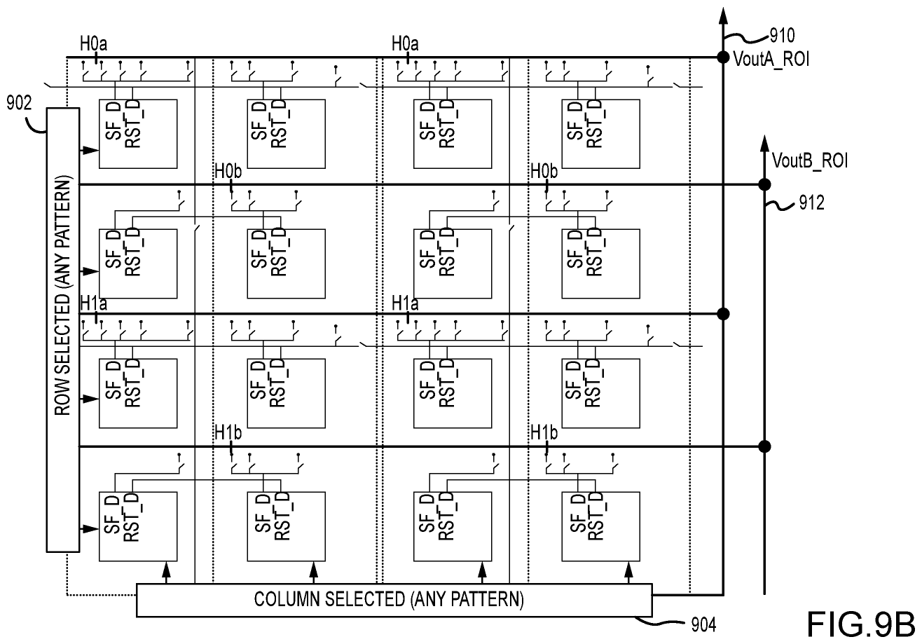

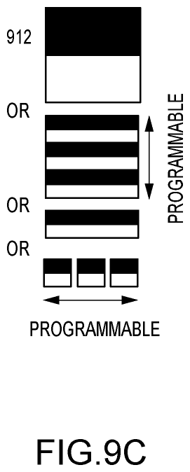

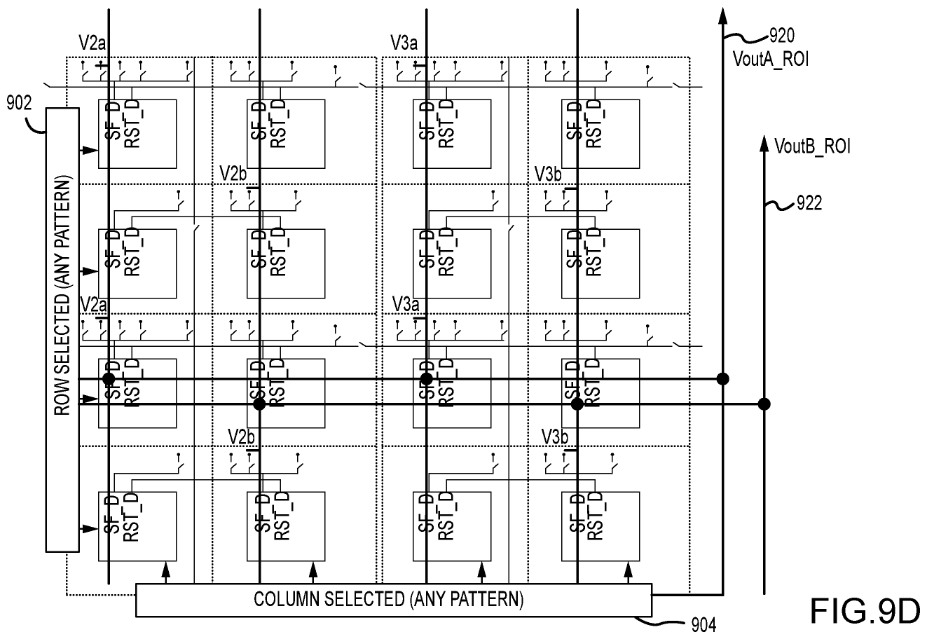

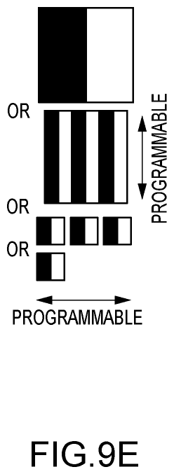

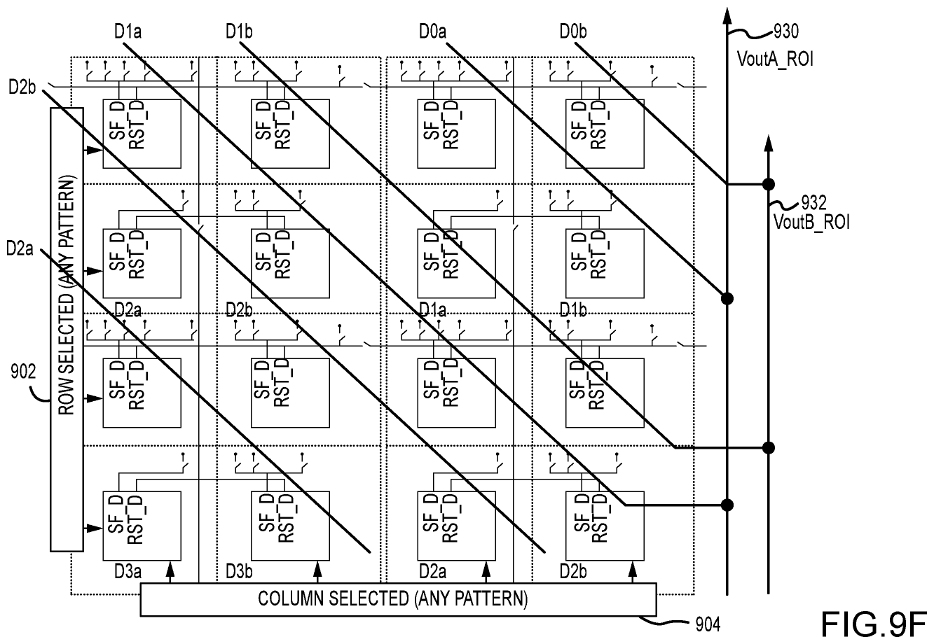

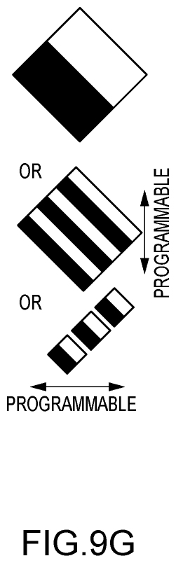

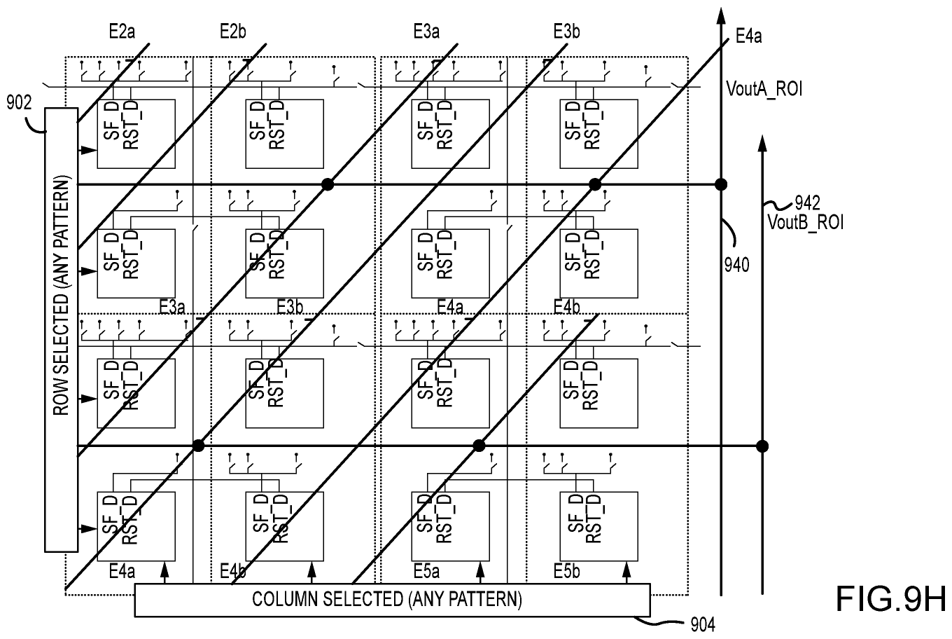

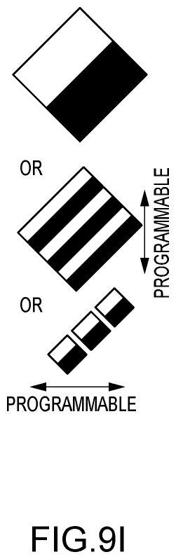

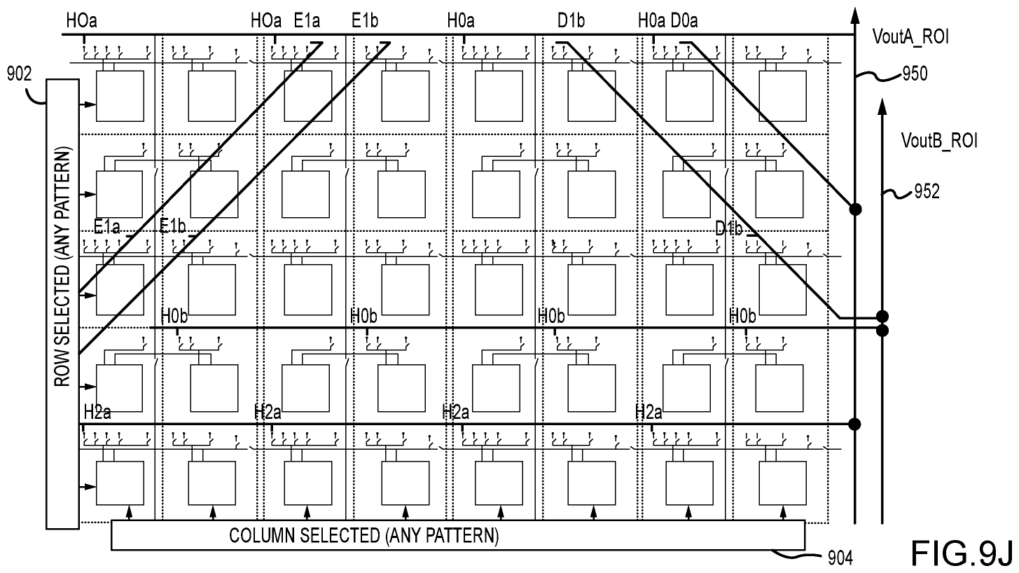

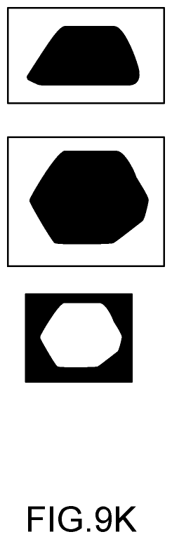

Pixels need not be limited to rectangular or square groupings. FIGS. 9A-9K illustrate the architecture for supporting determination of distances for different features/shapes in the scene. Correlating depth sensing with the shape of the external object being measured can help increase the accuracy of the TOF result. FIG. 9A is a diagram illustrating how row and column ROI selection can be controlled using row shift registers 902 and column shift registers 904 along with additional logic gates in accordance with an embodiment. For example, row shift registers 902 may be configured to output control signals to the row select transistors, reset transistors, charge transfer transistors, or other switching transistors within each pixel cluster. Column shift registers 904 may be configured to output control signals to the local ROI column switch (see, e.g., the column_select switches in FIG. 6A-6B) to control the local ROI connections. The row selection and column selection shift registers for controlling the various switch networks within each ROI unit cell may all be formed in the intermediate analog die 204.

FIG. 9B is a diagram illustrating how row and column ROI selection can be configured to support horizontal feature signal detection. Control signals H0a, H0b, H1a, H1b, H2a, and H2b enable the SF_D connection to outputs VoutA_ROI or VoutB_ROI. As shown in FIG. 9B, the upper clusters in each ROI unit cell are coupled together via horizontal lines and routed out as VoutA_ROI on path 910, whereas the lower clusters in each ROI unit call are coupled together via horizontal lines and routed out as VoutB_ROI on path 912. FIG. 9C is a diagram illustrating exemplary shapes that can be detected for depth sensing using the ROI selection scheme of FIG. 9B (the light area represents one time measurement slot for a feature at a particular distance and the dark area represents a second time measurement slot for the feature at a different distance). As shown in FIG. 9C, the grouping of rows and the segmentation of the rows are optionally programmable to enable detection of various types of edges or shapes.

FIG. 9D is a diagram illustrating how row and column ROI selection can be configured to support vertical feature signal detection. As shown in FIG. 9D, the left clusters in each ROI unit cell are coupled together via vertical lines and routed out as VoutA_ROI on path 920, whereas the right clusters in each ROI unit call are coupled together via vertical lines and routed out as VoutB_ROI on path 922. FIG. 9E is a diagram illustrating exemplary shapes that can be detected for depth sensing using the ROI selection scheme of FIG. 9D. Control signals Vxa/Vxb (where x=0,1,2,3) enable the SF_D connection to outputs VoutA_ROI or VoutB_ROI. As shown in FIG. 9E, the grouping of columns and the segmentation of the column are optionally programmable to enable detection of various edge/shape types.

FIG. 9F is a diagram illustrating how row and column ROI selection can be configured to support a +45° diagonal feature signal detection. As shown in FIG. 9F, a first diagonal group of pixels are coupled together and routed out as VoutA_ROI on path 930, whereas a second diagonal group of pixels are coupled together and routed out as VoutB_ROI on path 932. The two groups of pixels may be interleaved or alternating stripes in the diagonal direction. Control signals Dxa/Dxb (where x=0,1,2,3,4,5) enable the SF_D connection to outputs VoutA_ROI or VoutB_ROI. FIG. 9G is a diagram illustrating exemplary shapes that can be detected for depth sensing using the ROI selection scheme of FIG. 9F. As shown in FIG. 9G, the grouping of diagonal pixels and the segmentation of the diagonal stripes are optionally programmable to enable detection of various types of edges or shapes.

FIG. 9H is a diagram illustrating how row and column ROI selection can be configured to support a −45° diagonal feature signal detection. As shown in FIG. 9H, a first diagonal group of pixels are coupled together and routed out as VoutA_ROI on path 940, whereas a second diagonal group of pixels are coupled together and routed out as VoutB_ROI on path 942. The two groups of pixels may be interleaved or alternating stripes in the diagonal direction. Control signals Exa/Exb (where x=0,1,2,3,4,5) enable the SF_D connection to outputs VoutA_ROI or VoutB_ROI. FIG. 9I is a diagram illustrating exemplary shapes that can be detected for depth sensing using the ROI selection scheme of FIG. 9H. As shown in FIG. 9I, the grouping of diagonal pixels and the segmentation of the diagonal stripes are optionally programmable to enable detection of various types of edges or shapes.

FIG. 9J is a diagram illustrating how row and column ROI selection can be configured to detect a predetermined shape. As shown in FIG. 9J, a first subset of pixels are coupled together and routed out as VoutA_ROI on path 950, whereas a second subset of pixels are coupled together and routed out as VoutB_ROI on path 952. The two pixel subsets may demarcate or outline a non-regular or some other predetermined edge or shape. Control signals H/V/D/E enable the SF_D connection to outputs VoutA_ROI or VoutB_ROI. FIG. 9K is a diagram illustrating exemplary shapes that can be detected for depth sensing using the ROI selection scheme of FIG. 9J. As shown in FIG. 9K, detection of different irregular shapes having multiple edges angled at various orientations may be supported in this way.

The foregoing is merely illustrative of the principles of this invention and various modifications can be made by those skilled in the art. The foregoing embodiments may be implemented individually or in any combination.

What is claimed is:

1. Imaging circuitry, comprising:
a first pixel having a first source follower transistor with a first source follower drain terminal;
a second pixel having a second source follower transistor with a second source follower drain terminal; and
time-of-flight (TOF) measurement circuitry selectively coupled to the first and second pixels, wherein the TOF measurement circuitry is configured to determine a distance to an external object by sensing a change in current at the first and second source follower drain terminals.

2. The imaging circuitry of claim 1, wherein the first and second pixels are part of an array of pixels formed in an image sensor die, wherein the TOF measurement circuitry is formed in an additional die, and wherein the image sensor die is stacked directly on the additional die.

3. The imaging circuitry of claim 2, further comprising:
region of interest (ROI) switching circuitry that is formed in the additional die and that selectively shorts the first and second source follower drain terminals.

4. The imaging circuitry of claim 1, wherein the TOF measurement circuitry comprises:
an integrating circuit configured to generate an output voltage based on the change in current at the first and second source follower drain terminals.

5. The imaging circuitry of claim 4, wherein the TOF measurement circuitry further comprises:
a current memory circuit configured to supply current to the first and second source-follower drain terminals, wherein the current memory circuit comprises a switch that is turned on to allow the supply current to change and that is turned off to fix the supply current.

6. The imaging circuitry of claim 4, wherein the integrating circuit comprises:
an amplifier having a first input configured to receive a common mode voltage, a second input, and an output;
an integrating capacitor coupled across the second input and the output of the amplifier; and
an autozero switch coupled across the second input and the output of the amplifier.

7. The imaging circuitry of claim 4, wherein the TOF measurement circuitry further comprises:
a time-to-digital converter (TDC) configured to receive the output voltage from the integrating circuit.

8. The imaging circuitry of claim 7, wherein the time-to-digital converter is configured to output a first count value in response to the output voltage reaching a first predetermined threshold level and to output a second count value in response to the output voltage reaching a second predetermined threshold level.

9. The imaging circuitry of claim 8, wherein the first and second count values are used to extrapolate an arrival time for determining the distance to the external object.

10. The imaging circuitry of claim 1, wherein the first pixel is coupled to a column line, wherein the second pixel is coupled to the column line, and wherein the TOF circuitry further comprises:
a load circuit selectively coupled to the column line, wherein the load circuit is operable in a first mode to drive the column line to a common mode voltage level and is further operable in a second mode to supply a fixed current to the column line.

11. The imaging circuitry of claim 1, wherein the first and second pixels are coupled to a first column line, the imaging circuitry further comprising:
a third pixel having a third source follower transistor with a third source follower drain terminal; and
a fourth pixel having a fourth source follower transistor with a fourth source follower drain terminal, wherein the third and fourth pixels are coupled to a second column line, and wherein the TOF measurement circuitry is further configured to sense a change in current at the third and fourth source follower drain terminals.

12. The imaging circuitry of claim 11, wherein the TOF measurement circuitry comprises a dual configuration load circuit operable to drive the first and second column lines to a common mode voltage level and to supply a fixed current to the first and second column lines.

13. The imaging circuitry of claim 11, wherein the TOF measurement circuitry comprises a current memory circuit coupled to the first, second, third, and fourth source follower drain terminals.

14. The imaging circuitry of claim 11, wherein the TOF measurement circuitry comprises a current integrating circuit having a first input selectively coupled to the first and second source follower drain terminals and the second input selectively coupled to the third and fourth source follower drain terminals.

15. A method of operating imaging circuitry, comprising:
with an image sensor pixel, detecting a photon within a photon detection window, wherein the image sensor pixel has a source follower transistor with a source follower drain terminal;
using an integrating circuit coupled to the source follower drain terminal to sense a change in current at the source follower drain terminal;
using the integrating circuit to generate an output voltage in response to sensing the change in current at the source follower drain terminal; and
using the output voltage to compute a time of arrival of the photon to determine a distance between the imaging circuitry and an external object.

16. The method of claim 15, wherein the source follower drain terminal is coupled to a current memory circuit, the method further comprising:
opening the photon detection window by configuring the current memory circuit as a fixed current source.

17. The method of claim 16, wherein the image sensor pixel has a column output line that is selectively coupled to a load circuit, the method further comprising:
closing the photon detection window by configuring the load circuit as a fixed current sink.

18. The method of claim 15, further comprising:
preventing additional photons striking the image sensor pixel outside the photon detection window from affecting the computed time of arrival.

19. The method of claim 15, further comprising:
using a time-to-digital converter (TDC) to generate a first timestamp when then output voltage reaches a first threshold level and to generate a second timestamp when the output voltage reaches a second threshold level;
using the first and second timestamps to compute a rate of change in the output voltage; and
using the computed rate of change to extrapolate the time of arrival.

20. Imaging circuitry, comprising:
an array of pixels configured to image a scene; and
distance measurement circuitry coupled to a selected subset of pixels in the array of pixels, wherein the distance measurement circuitry is configured to detect a signal change from the selected subset of pixels in response to the selected subset of pixels receiving a photon within a photon acquisition time slot having a leading edge triggered by a first switch toggling in the distance measurement circuitry and a trailing edge triggered by a second switch toggling in the distance measurement circuitry.

21. The imaging circuitry of claim 20, wherein the distance measurement circuitry comprises a converter circuit configured to obtain multiple timestamps in response to the photon received within the photon acquisition time slot.

22. The imaging circuitry of claim 20, wherein the distance measurement circuitry is further configured to perform depth sensing on external objects with features selected from the group consisting of: horizontally oriented features, vertically oriented features, diagonally oriented features, and irregular features.
